(19) United States
(12) Patent Application Publication
(10) Pub. No.: US 2017/0217396 A1
(43) Pub. Date: Aug. 3, 2017

(54) DELIVERY SYSTEM FOR A VEHICLE

(71) Applicant: Ranger Design, Montreal (CA)

(72) Inventor: Ilko Paunov, Laval (CA)

(21) Appl. No.: 15/421,806

(22) Filed: Feb. 1, 2017

Related U.S. Application Data
(60) Provisional application No. 62/289,564, filed on Feb. 1, 2016.

(51) Int. Cl. B60R 21/02; B62D 33/04; B60P 1/43

(52) U.S. Cl. CPC B60R 21/026; B60P 1/435; B62D 33/04

(57) ABSTRACT

The present invention discloses a delivery system for use in a vehicle having a driver's compartment with a driver seat and a cargo area. The delivery system includes a partition adapted to be mounted within the vehicle to separate the driver's compartment from the cargo area. The partition has an opening adjacent the driver seat. A sloping tray is positioned within the cargo area and extends longitudinally along the cargo area through the opening in the partition and into the driver's compartment. The sloping tray terminates adjacent the vehicle driver seat. The sloping tray slopes downwardly from the cargo area to the driver's compartment. Items upon the sloping tray slide from the cargo area into the driver compartment to adjacent the vehicle driver seat for easy delivery.

### RELATED APPLICATIONS

This application claims the benefit of U.S. Provisional Application No. 62/289,564 filed on Feb. 1, 2016, the entire disclosure of the application being considered part of the disclosure of this application and hereby incorporated by reference.

### STATEMENT REGARDING FEDERALLY SPONSORED RESEARCH

NONE.

### TECHNICAL FIELD

This invention relates generally to delivery vehicles and more specifically to package delivery vehicles.

### BACKGROUND OF THE INVENTION

It is desirable to provide a delivery system for a vehicle that doesn't require the driver to leave the driver's seat, but still provides a partition to shield the driver from items in the cargo area. It is well known to provide a partition between the driver's compartment and the cargo area to protect the driver of a vehicle from the inadvertent movement of items from the cargo area into the driver's compartment. It is also well known to provide various storage systems in a vehicle for storing items before delivery. With the known delivery vehicles, the driver must leave the driver's seat and open the cargo department to retrieve items for delivery.

What is needed is a delivery system that will shield the driver form the cargo area but simultaneously allow the driver to retrieve items for delivery without leaving the driver's seat.

### SUMMARY OF THE INVENTION

In general terms, this invention provides an effective delivery system that provides a shield for the driver from items in the cargo area and allows the driver to deliver items without leaving the driver's seat.

The present invention discloses a delivery system for use in a vehicle having a driver's compartment with a driver seat and a cargo area. The delivery system includes a partition adapted to be mounted within the vehicle to separate the driver's compartment from the cargo area. The partition has an opening adjacent the driver seat. A sloping tray is positioned within the cargo area and extends longitudinally along the cargo area through the opening in the partition and into the driver's compartment. The sloping tray terminates adjacent the vehicle's driver seat. The sloping tray slopes downwardly from the cargo area to the driver's compartment. Items upon the sloping tray slide from the cargo area into the driver compartment to adjacent the vehicle driver seat for easy delivery.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a partial perspective view of the delivery system for a vehicle as viewed from the rear of the cargo area of a vehicle.

FIG. 2 is a side view of the delivery system for a vehicle as viewed from the driver compartment of a vehicle.

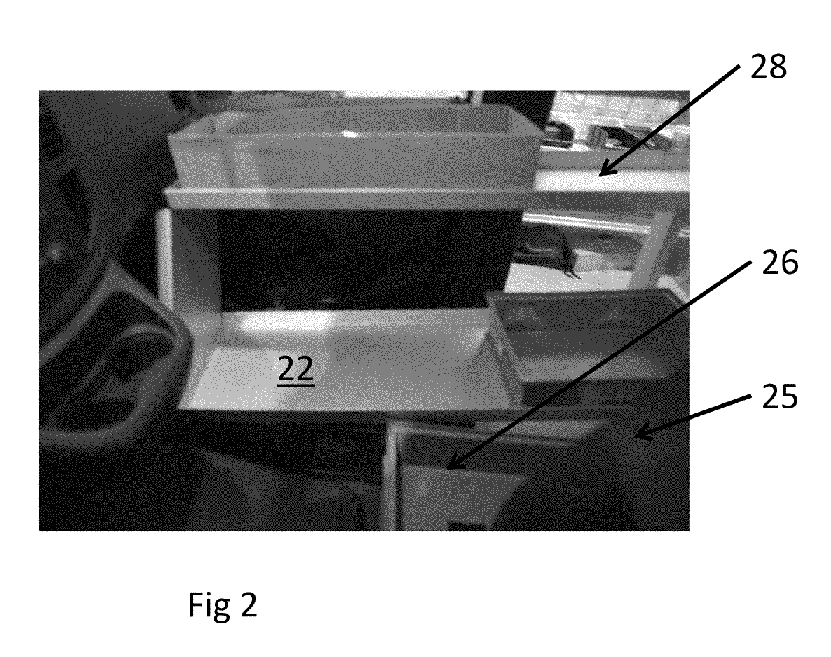

FIG. 3 is a partial side view of the delivery system for a vehicle as viewed from the side of a vehicle.

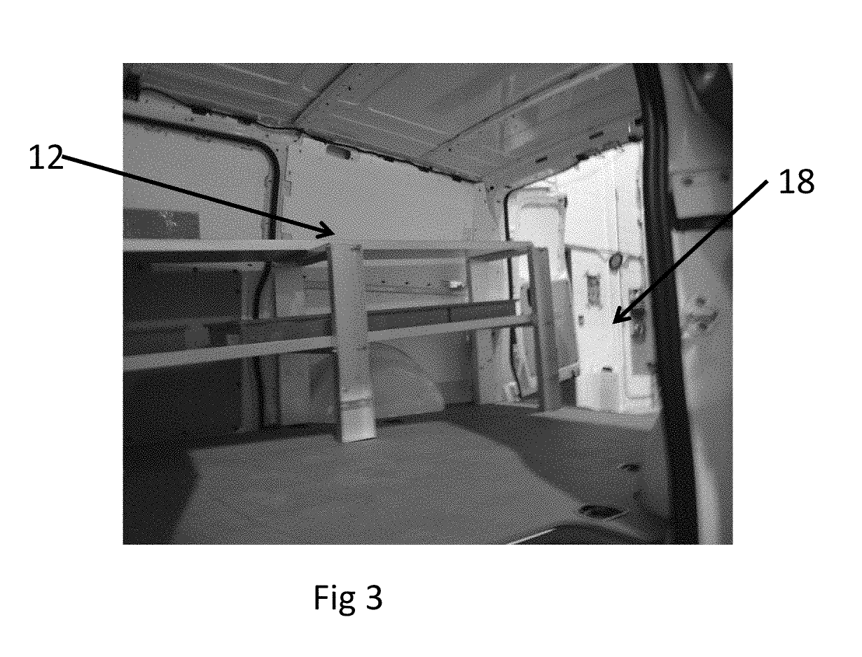

### DETAILED DESCRIPTION OF A PREFERRED EMBODIMENT

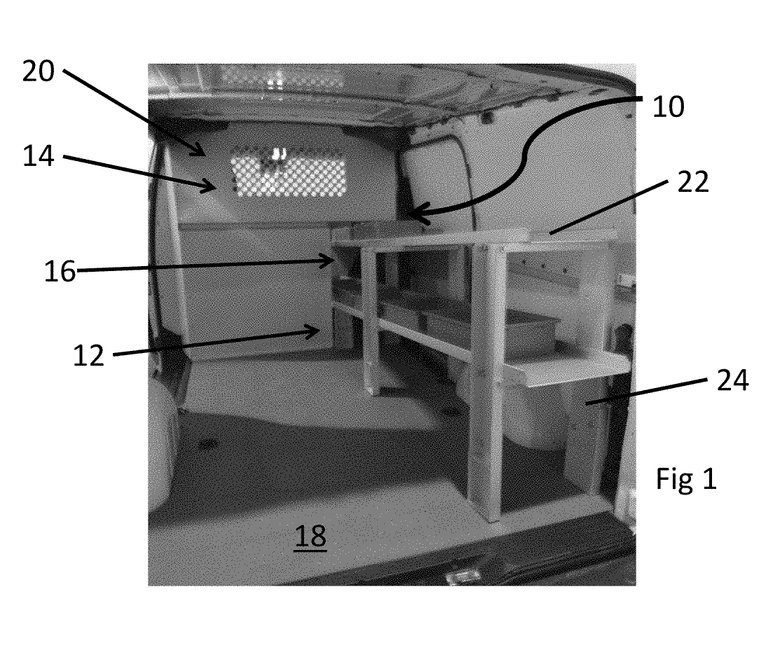

The delivery system for a vehicle of the present invention is shown generally at 10 in FIG. 1. The delivery system 10 includes a sloping tray shown generally at 12 and a partition 14. The partition 14 has an opening 16 that receives a portion of the sloping tray 12.

The partition 14 divides the cargo area 18 of the vehicle 20 from the driver's compartment 26. The partition 14 prevents items in the cargo area 18 from inadvertently entering the driver's compartment 26. As those of ordinary skill will appreciate, items in the cargo area 18 could shift, for example upon sudden hard braking of the vehicle, and the partition 14 will prevent them from entering the driver's compartment 26.

The sloping tray 12 slopes from the rear cargo area 18 of the vehicle 20 through the opening 16 in the partition 14. The tray 12 terminates adjacent the driver seat 25 in the driver's compartment 26 of the vehicle 20.

The sloping tray 12 has at least one tray 22 and in the disclosed embodiment two trays 22. The trays are supported upon support legs 24. It will be understood that the trays 22 could be mounted to the walls of the vehicle if desired and eliminates the need for legs 24.

To use the delivery system 10, items such as packages or as illustrated bins are loaded onto the trays 22. The items can easily be loaded at the rear 18 of the vehicle 20. The items are loaded onto the trays 22 with the first items to be delivered being loaded first through the last of the items to be delivered. As will be appreciated, the items will slide down the trays 22 into the driver's compartment 26 on the passenger's side of the vehicle. The two levels of sloped trays 22 in the vehicle 20 will ensure that the items on the trays 22 will slide to the front of the vehicle 20 making it easier for the driver to deliver and not leave the driver's seat 25.

With the opening 16 being on the passenger side of the vehicle 20 the items will slide through from the cargo area 18 to the driver's compartment while still providing a shield for the driver with the remaining partition 14.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A delivery system for use in a vehicle, the vehicle having a driver's compartment with a driver seat and a cargo area, said delivery system comprising:
a partition adapted to be mounted within the vehicle to separate the driver's compartment from the cargo area, said partition having an opening adjacent the driver seat;
a sloping tray positioned within the cargo area and extending longitudinally along the cargo area through the opening in said partition, said sloping tray terminating adjacent the vehicle driver seat, said sloping tray sloping downwardly from the cargo area to the driver's compartment;
whereby items upon said sloping tray slide from the cargo area into the driver compartment to adjacent the vehicle driver seat for easy delivery without the need for the driver to leave his driver's seat.

2. The delivery system of claim 1, wherein said sloping tray has two spaced trays.

3. The delivery system of claim 1, wherein said sloping tray is supported upon support legs.

4. The delivery system of claim 1, wherein said opening in said partition has a width that is generally equal to the width of said sloping tray.
